(19) United States
(12) Patent Application Publication
(10) Pub. No.: US 2011/0153080 A1
(43) Pub. Date: Jun. 23, 2011

(54) METHOD AND APPARATUS FOR INDUSTRIAL ROBOTIC PATHSCYCLE TIME OPTIMIZATION USING FLY BY

(75) Inventors: Tal Shapiro, Tel Aviv (IL); Ido Haskel, Jerusalem (IL); Alex Grinberg, Rehovot (IL)

(73) Assignee: SIEMENS PRODUCT LIFECYCLE MANAGEMENT SOFTWARE INC., Plano, TX (US)

(21) Appl. No.: 12/971,020

(22) Filed: Dec. 17, 2010

Related U.S. Application Data
(60) Provisional application No. 61/289,190, filed on Dec. 22, 2009.

(51) Int. Cl. G05B 19/04

(52) U.S. Cl. 700/255

(57) ABSTRACT

A system, method, and computer readable medium. A method for robotic path planning includes receiving a robotic path for a robot and associating a plurality of zones with each location in the robotic path. The method also includes selecting for each location one of the zones associated with the location and simulating motion of the robot over the robotic path using the locations and selected zones. The method further includes determining whether a collision occurred in the simulated motion of the robot. The method still further includes, if there was a collision, identifying a location associated with the collision, selecting a new zone for the identified location other than the currently selected zone, and repeating the steps of simulating motion of the robot and determining whether a collision occurred. The method also includes, if there wasn't a collision, assigning to each location its currently selected zone.

### CROSS-REFERENCE TO RELATED APPLICATIONS

The present application is related to U.S. Provisional patent Application No. 61/289,190, filed Dec. 22, 2009, entitled “METHOD AND APPARATUS FOR INDUSTRIAL ROBOTIC PATHS CYCLE TIME OPTIMIZATION USING FLY-BY”. Provisional Patent Application No. 61/289,190 is assigned to the assignee of the present application and is hereby incorporated by reference into the present application as it fully set forth herein. The present application hereby claims priority under 35 U.S.C. §119(e) to U.S. Provisional Patent Application No. 61/289,190.

### TECHNICAL FIELD

The present disclosure is directed, in general, to computer aided design, manufacturing, and visualization systems (individually and collectively, “CAD systems”), robotics, and automated industrial operations.

### BACKGROUND OF THE DISCLOSURE

Industrial robots are widely used for processes such as spot and arc welding, object handling, and assembly. One of the major challenges for robot programmers is the programming of a collision free path.

### SUMMARY OF THE DISCLOSURE

Various embodiments include a data processing system, method, and computer readable medium, A method for robotic path planning includes receiving a robotic path for a robot and associating a plurality of zones with each of a plurality of locations in the robotic path. The method also includes selecting for each location a currently selected one of the plurality of zones associated with the location and simulating motion of the robot over the robotic path using, for each of the plurality of locations, the currently selected zone for the location. The method further includes determining whether a collision occurred in the simulated motion of the robot. The method still further includes, if a collision is determined to have occurred, identifying a location associated with the collision, selecting as a new currently selected zone for the identified location one of the plurality of zones associated with the location other than the currently selected zone, and repeating the steps of simulating motion of the robot and determining whether a collision occurred. The method also includes, if a collision is determined not to have occurred, assigning to each location the zone currently selected for the location.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the concept and the specific embodiment disclosed as a basis for modifying or designing other structures for carrying out the same purposes of the present disclosure, Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts velocity and acceleration profiles for two movements toward and away from a via location;

FIG. 3 depicts an example of a location-zone graph in accordance with disclosed embodiments;

FIG. 4 depicts an example of applying a process in accordance with various disclosed embodiments;

FIG. 5 depicts an automatic path planning process;

FIG. 6 depicts an automatic path planning process in accordance with disclosed embodiments; and

FIG. 7 depicts a zone assignment process in accordance with disclosed embodiments.

### DETAILED DESCRIPTION

The figures, illustrations, and examples discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Industrial robots are widely used for processes such as: spot and arc welding, object handling, and assembly. One task programmers of industrial robots perform is programming a path from an initial configuration of the robot (a “source configuration”, “initial position”, or “beginning location”) to a final configuration of the robot (a “target configuration”, “final position”, or “ending location”). One requirement of a path is that the robot does not collide with elements of its industrial environment while traversing the path. A measured characteristic of the path that is typically optimized is the “cycle time,” or elapsed time in moving the robot from the source configuration to the target configuration. The programmer seeks a path that moves from source to target configuration in an acceptably short period of time.

Robot cycle time has a significant influence on throughput of the work cell in which the robot is used. Reducing the cycle time by optimizing the robotic path is one of the main challenges facing robot programmers, which process is often complex and time-consuming. Providing automated methods to assist robot programmers in creating optimized paths or further optimizing existing paths can both reduce planning time and also improve the cycle time of the resulting path.

Creating a collision free path between source and target robot configurations is typically done by adding a series of intermediate configurations (also known as “waypoints” or “via locations”) through which the robot can safely traverse, without colliding with the static environment. Simple motion along this path (without any special motion instructions) results in a point-to-point motion, during which the robot fully stops (i.e. reaches zero speed) at every via location. This can provide an erratic motion profile which imposes stress on the robot and loses time on acceleration and deceleration, increasing the cycle time for such simple motion.

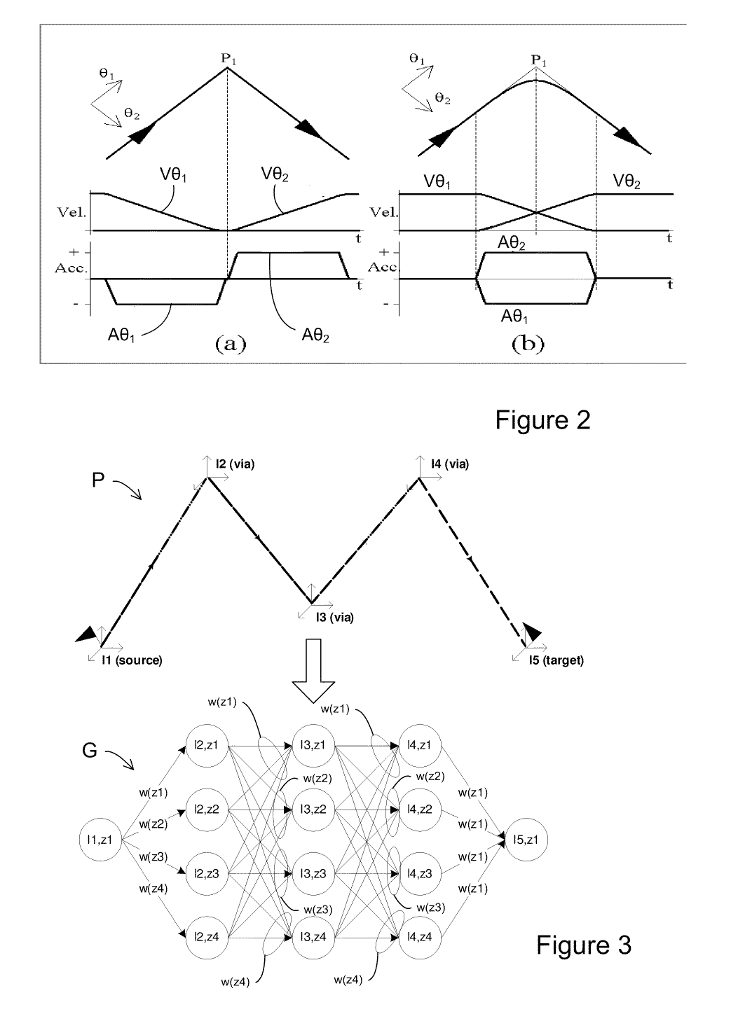

In order to achieve a path with less variation in velocity and smoother motion, some robot controllers provide the functionality of “fly-by” parameters in motion instructions. Fly-by values are assigned to via locations and instruct the robot controller to look ahead and start the movement towards the next location in sequence before reaching the location currently being approached. Robot controller specific fly-by values are also known as “zones,” although the terms fly-by and zone may also be used interchangeably in this disclosure. By smoothing the changes of direction at via locations and providing less variation in the robot's velocity profile, fly-by values can significantly reduce a cycle time for a path, as well as reduce dynamic loads on the drive and brake mechanisms of the robot's joints. A larger zone indicates that more “freedom” is permitted, allowing larger distance between the robot trajectory and an actual via location—that is, allowing the robot to miss the via location by a greater distance, Thus, a larger zone requires less, or no, deceleration, while a smaller zone requires higher accuracy of the robot trajectory with respect to the path through a via location and higher deceleration. A zero zone (or “fine zone” or “no fly-by”) indicates that the robot must exactly reach the location, with a full stop, before moving towards the next location. Zero zones are illustrated in FIG. 2, discussed below.

Fly-by settings (or zones) therefore play an important role in the process of path cycle time optimization performed by a robot programmer. However, zones also pose a difficulty since zones influence the actual trajectory followed by the robot in traversing the path, the path is not guaranteed to remain collision free once zones have been applied. Balancing between the requirement to maintain a collision free path and the goal of optimizing cycle time by smoothing the robot's motion is therefore a significant challenge.

Following are short definitions of the usual meanings of some of the technical terms which are used in this disclosure. however, those of ordinary skill will recognize when such terms are used herein in a context that requires a different meaning. Additional definitions may be found in the standard. technical dictionaries and journals,

Industrial robot—An industrial robot is officially defined by ISO as an automatically controlled, reprogrammable, multipurpose manipulator programmable in three or more axes (or “joints”), The field of robotics may be more practically defined as the study, design and use of robot systems for manufacturing (a top-level definition relying on the prior definition of a robot).

Robot configuration—The robot position, defined by the position of each of the robot (driving) joints.

Point-To-Point (PTP) motion—Robot motion from one configuration to another. Unless specified otherwise by the operator, the robot controller takes the joint values and calculates the shortest distances to the desired joint value. Modern robot controllers typically coordinate joint movements using Fully Synchronized PTP Motion, i.e., synchronizing both the time to reach the destination and the times for acceleration and deceleration

Robotic path—A list of points or “locations” defining the position and orientation of the robot End Of Arm, also known as Tool Center Point Frame (or TCPF).

Robot trajectory The trajectory of the robot TCPF during motion along a robotic path.

Via location—An intermediate location added between a source location and a target location, through which the robot can safely traverse, without colliding with the static environment.

Cycle time—A time that elapses between the beginning and the end of a process.

Computer Aided Robotics (CAR) Tools—Software for designing, manufacturing, installing and programming industrial robots processes on the factory floor.

Generic (Standard) Robot Controller—Software component that employs a generic model for fast and accurate motion planning from a source robot configuration to a target robot configuration. Robot specific motion instruction such as fly-by are typically not handled well by such a generic model.

Realistic Controller Simulation (RCS) Module—Software component developed by the robot vendor, enabling accurate simulations in virtual systems, utilizing robot controller specific motion behavior.

Realistic Robot Simulation (RRS) interface—A common interface through which a virtual simulation system may communicate with an RCS module.

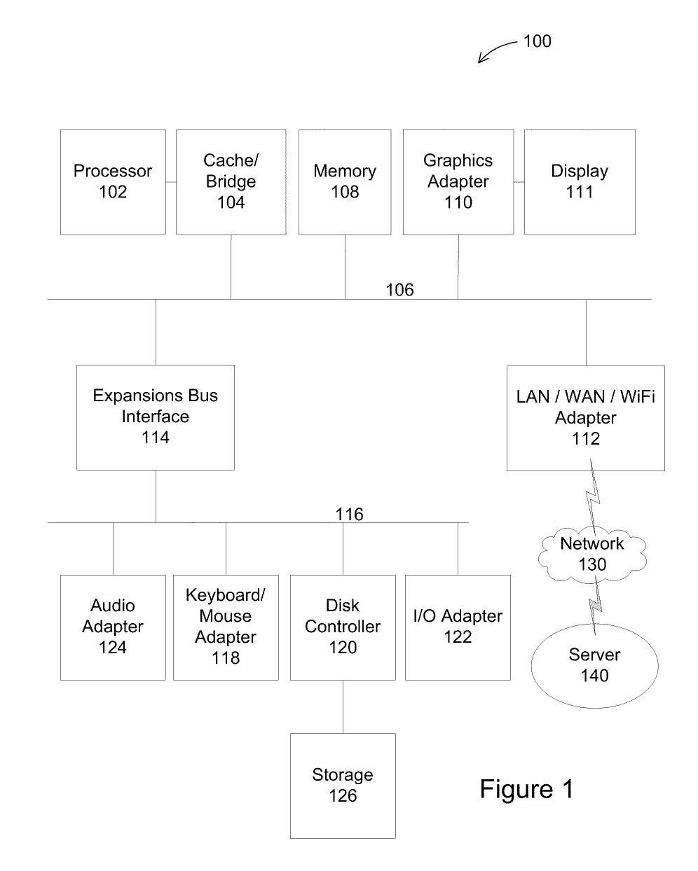

FIG. 1 depicts a block diagram of a data processing system in which an embodiment can be implemented, for example as a system configured to perform processes disclosed herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc,

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100,

The data processing system 100 may be modified to operate as a robotic path planning system and configured to perform processes as described herein, Such robotic path planning systems generate robotic paths having selected characteristics such as being collision free, having a minimal cycle time, or other desirable attributes.

FIG. 2 depicts velocity and acceleration profiles for two movements toward and away from a via location P₁, as described in the Hein reference cited below. Point P₁ is an end point of a first movement and a starting point of a second movement. White moving toward P₁, only joint 1 (θ₁) of the robot is changing, while joint 2 (θ2) of the robot remains static, While moving away from P₁, only θ₂ is changing, while θ₁ remains static. Part (a) of FIG. 2 illustrates motion without a zone (or with a “zero zone” or “fine zone”)—that is, the robot stops at P₁ before moving away. Part (b) of FIG. 2 illustrates motion with a zone—that is, motion of θ₁ has not yet stopped when motion of θ₂ begins. Lines indicated by Vθ₁ and Vθ₂ represent velocities of joints θ₁ and θ₂, respectively. Lines indicated by Aθ₁ and Aθ₂ represent accelerations of joints θ₁ and θ₂, respectively.

Computer Aided Robotics (CAR) Tools may be used for path planning, however, the optimization of a path is typically very time-consuming. In particular, relying on a robot programmer to manually choose a best set of zones or decide which via, location to shift is a process based on trial and error and is strongly dependent on the programmer's expertise.

Path planning processes have been developed that attempt to find an efficient, collision-free path. Such path planning processes are often based on a standard (generic) robot controller model, which is used to simulate Point-to-Point motions quickly and accurately. Many modem robot controllers use a similar model for motion planning from a source configuration to a target configuration (using Fully Synchronized PTP Motion). It is therefore possible to plan a “raw” collision free path (with no zones) using a standard (generic) robot controller without using an actual robot controller (RCS module).

Adding zones to a path in an attempt to improve cycle time may make the path planning process more complicated. When zones are applied, the trajectory of the robot no longer depends solely on the source and target configurations and the individual way points chosen. With zones, the trajectory of the robot past a via location is additionally influenced by the locations that precede and follow the via of interest. Furthermore, although the basic concepts of fly-by are similar in modern robot controllers, the way they are implemented and the meaning of the fly-by parameters may differ in robot controllers from various robot vendors. For example, a fly-by parameter may represent the distance from the via location measured in millimeters, or it may represent speed measured as a percentage of the maximum velocity of the robot. As implemented by a robot controller, a fly-by may be any motion instruction or combination of motion instructions that are associated with a robotic path location and allow the robot TCPF to pass near the location without stopping, rather than reaching the location and coming to a full stop. Therefore, a robot programmer may have difficulty obtaining accurate predictions of trajectory and cycle time for a path having zones with a path planning process that makes use of a generic robot controller.

Some systems achieve an accurate trajectory by simulating the path using an actual industrial robot controller, rather than by performing a series of consecutive Point-To-Point movements, However, industrial robot controllers typically employ a complex internal logic and running such simulations may be a time consuming task.

Efficient methods and processes according to the disclosure use an industrial robot controller to calculate an optimal list of zones for a given path, while keeping the path collision free. This can be highly beneficial in automated cycle time optimization processes. Such processes may be employed, for example, within a fitness function of simulated annealing or genetic algorithms for path planning.

Methods and processes according to the disclosure can efficiently find an optimal (or near-optimal) set of fly-by values for a given path (that is, fly-by values that yield an optimal (or near-optimal) cycle time), while keeping the path collision free when implemented in the shop-floor. The disclosed method can be used in a CAR-Tool, where the robot motion will be calculated using a Realistic Controller Simulation (RCS) Module via the RRS standard interface.

In some embodiments, two assumptions are made:
Assumption 1: Larger Fly-by values require less or no deceleration, tend to reduce cycle time, and therefore should be preferred over smaller values; and
Assumption 2: The Fly-by parameter affects the robot trajectory in a limited range around the location. Starting from a collision free path, a collision during a motion between two adjacent locations can only occur following assignment of fly-by values on either of them, but not on other locations outside this scope.

For some embodiments, an additional assumption is also made:
Assumption 3 (optional): Paths which cause collisions without zones are considered invalid, even if the collisions can be avoided once zones are applied.

The inputs to various embodiments include a robotic path P and a set of zones S. A zone from the set S may be assigned to each waypoint in the path P. One zone in the set S is the “fine” (or zero) zone. Each zone in the set S is assigned a numerical weight, which can be, for example, inversely proportional to its size (i.e., small weights for large zones and large weights for small zones).

In some embodiments, the system verifies that the input path is collision-free before assigning zones. In other embodiments, Assumption 3 is applied when the path is not otherwise guaranteed to be collision free without zones. Such embodiments simulate P with “fine” zones assigned to each waypoint and check the simulated path for collisions. An error may be signaled if a collision is detected in the simulated path,

In some embodiments, in a succeeding step, the system builds (or creates) a weighted directed graph G, for example as described below: Each vertex in the graph corresponds to a location-zone pair. Vertices are created for all pairs {(l,z)|lεP,zεS}, except for the first and last locations of the path, which have only a single node, associated with a “fine” zone. Edges are created to couple all vertices of adjacent locations in P. The edge direction corresponds to the order of the path—from a location/zone pair vertex of a location to each location/zone pair vertex of the next (or subsequent) location in the path. Edges are assigned with a weight that is equal to the weight of the target vertex zone.

FIG. 3 depicts an example of such a graph. An input path P with 5 locations is translated to graph G. Set S consists of 4 zones: z₁-z₄, where z₁ is a smallest zone and z₄ is a largest zone. The zone z₁ may be a fine, or zero, zone. The weight function w( ) maps each zone to its weight. Values for w( )in an exemplary embodiment may be w(z₁)=10, w(z₂)=5, w(z₃)=2, and w(z₄)=1. In other embodiments, more or fewer zones may be used and other weights may be assigned to the zones.

A process according to the disclosure modifies the graph G iteratively in order to find a collision-free path with an acceptably short cycle time. The process achieves this goal by seeking a set of edges that correspond to a lowest possible weight (i.e., the largest possible zones) and represent a path that is collision-free during simulation.

In some embodiments, the process for finding a collision-free path with an acceptably short cycle time is as follows. At each step, the process applies Assumption 1 and uses the existing set of edges to find a path between the vertex of the first location and the vertex of the last location having a shortest cycle time, a path having a minimal sum of the weights of its constituent edges, If no such path exists (due to the removal of edges, as described below), the process stops and returns an error, indicating that collisions cannot be avoided by any combination of zones for the locations in P and thus the input path P is invalid. Finding a shortest path may be achieved by utilizing a single source shortest path method,

Since edges connect only vertices of adjacent locations in P, and because the graph is constructed in topological order of the path, a valid path between the first and last vertices must consist of a single vertex corresponding to each location in P. An important observation is that the process minimizes the sum of weights of the vertices' zones.

Next, the candidate list of zones is validated as collision-free. The calculated shortest path represents a list of locations with candidate zones. To evaluate the validity of the candidate zones in terms of collisions, the corresponding zones are applied on the locations and the path is simulated using RRS. The process records a simulated cycle time for the path. If collisions occur during the simulation, the process records information identifying the locations between which collision occurred. In some embodiments, information relating to proximity of the collision to one of the locations may be recorded.

Applying Assumption 2, any collision that occurs during the motion from one location to the next indicates that at least one of the locations was assigned an invalid zone, and thus the combination of the two zones is invalid for these locations. Therefore, whenever collisions are detected, the process removes from G the edges that connect between the vertices that correspond to the invalid locations-zones pairs.

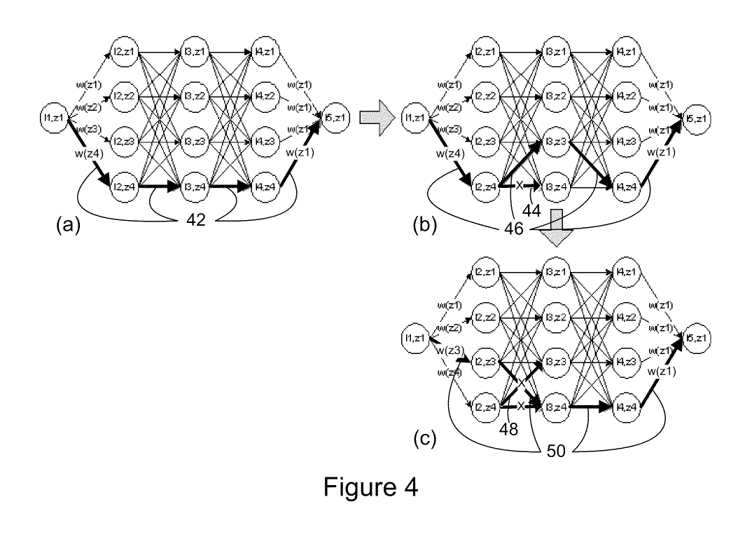

FIG. 4 depicts an example of applying a process in accordance with disclosed embodiments. After graph G has been generated, a first shortest path 42 is selected that consists of vertices corresponding to the largest zones in S, as shown in part (a) of FIG. 4. Using the exemplary assignment of weights to zone sizes described above, the weight of the edges of this first shortest path is 13. When simulating P with this first set of candidate zones, a collision is found during motion from l₂ to l₃. Consequently, the edge 44 connecting vertex (l₂,z₄) and (l₃,z₄) is removed and a second shortest path is found, as shown in part (b) of FIG. 4. The weight of the edges of this second shortest path is 14. When simulating P with this second set of candidate zones, a collision is found, again during motion from l₂ to l₃. Consequently the edge 48 connecting vertex (l₂,z₄) and (l₃,z₃) is removed and a third path 50, also with a weight of 14, is found, as shown in part (c) of FIG. 4.

After each step of edge removal, the process re-applies Assumption 1 and uses the remaining set of edges to find a path between the vertex of the first location and the vertex of the last location having a shortest cycle time, i.e., a path having a minimal sum of the weights of its constituent edges. When a collision-free path is found, the process stops and returns the list of zones and the measured simulated cycle time.

Complexity of a process according to the disclosure may be measured in terms of number of RRS simulations. Given a path P with n locations and a set S with m zones, the complexity of a naïve process that scans all the possible combinations of locations and zones is: O(mⁿ). The worst case complexity of a process according to the disclosure is bounded by the number of edges in G and equals: O(m²n).

However the average complexity of a process according to the disclosure is even lower than O(m²n). In theory, changing a zone on one location may cause collisions which require changing the zone on an adjacent location. This might result in a long chain reaction spanning the entire path. However, in practice, such coupling between separate segments of the path is limited and the influence of the number of locations (n) on the complexity is low. The average complexity of a process according to the disclosure is therefore close to O(m²).

An improvement in performance can be achieved by generalizing assumption 3 to state: Paths which cause collisions with a smaller zones are also considered invalid for larger zones. That is: “zone size is not increased to avoid collisions,” This is based on the observation that collisions that occur during motion between two locations with small zones, often occur also during motion between those same two locations with larger zones. As a result, a process according to the disclosure may run one or more preliminary simulations using zones of one or more intermediate sizes and, when a collision is detected in one of the simulations, remove edges for the associated intermediate zones and any larger zones, thereby further reducing the number of candidate paths in the graph G.

Processes according to the disclosure may further improve performance by omitting so-called “ineffective edges”. Some robot controllers pose restrictions on zones based on the distance between successive locations. When an operation subject to such robot controller restriction is performed, the zone is reduced by the robot controller even if a larger zone is specified. By considering robot controller-specific restrictions, “ineffective edges” that correspond to large zones assigned to nearby locations can be omitted during the graph generation phase, further reducing the number of candidate paths through the graph G.

As such, fast and accurate processes described herein provide a good estimation of an optimal list of zones and a best cycle time for a given robot movement path, and can be beneficial in CAR-Tools, for both manual and automated path planning and optimization processes.

Manual Path Planning: Processes and systems according to the disclosure may be used as an independent tool to assist an Off-line programming (OLP) engineer during a manual path planning and optimization process. Such a process can indicate to the programmer that there exists a set of zones that can be assigned safely to a candidate path. In addition, a list of zones calculated by such a process may give the programmer an important view on the bottlenecks of the robotic path, that is, locations with small zones that might be repositioned to allow larger zones, resulting in a shorter cycle time for the robotic path.

Automated path planning processes: Processes and systems according to the disclosure may be employed in automated path planning and optimization processes to evaluate the quality of candidate robotic paths by estimating a path's potential cycle time when zones are applied. That is, collision-free robotic paths may be created without using zones, using the existing techniques for standard robot controllers. Such a method applies Assumption 3, as only collision free paths with “fine” zones are processed further. Then, processes and systems according to the disclosure may be utilized to assign zones and better estimate a shortest possible cycle-time for a candidate robotic path.

In some automated processes, the cycle time estimated by the process can be used as a powerful Objective function in metaheuristic path planning methods such as simulated annealing and genetic algorithms. Typically, communication between the CAR-Tool and the RCS Module may be done via the RRS1 standard interface.

For clarity of explanation, a path is described as composed of a start location, one or more waypoint locations, and an end location, Additional vias or waypoint locations may be added as needed to avoid collisions. In actuality, a complete robotic path typically includes a plurality of such segments of start, waypoint, and end locations, where an action is performed by the robot tool at each end location before commencing motion along the next segment of the robotic path. Because the robot begins and ends each segment at a complete stop, each segment may be processed independently.

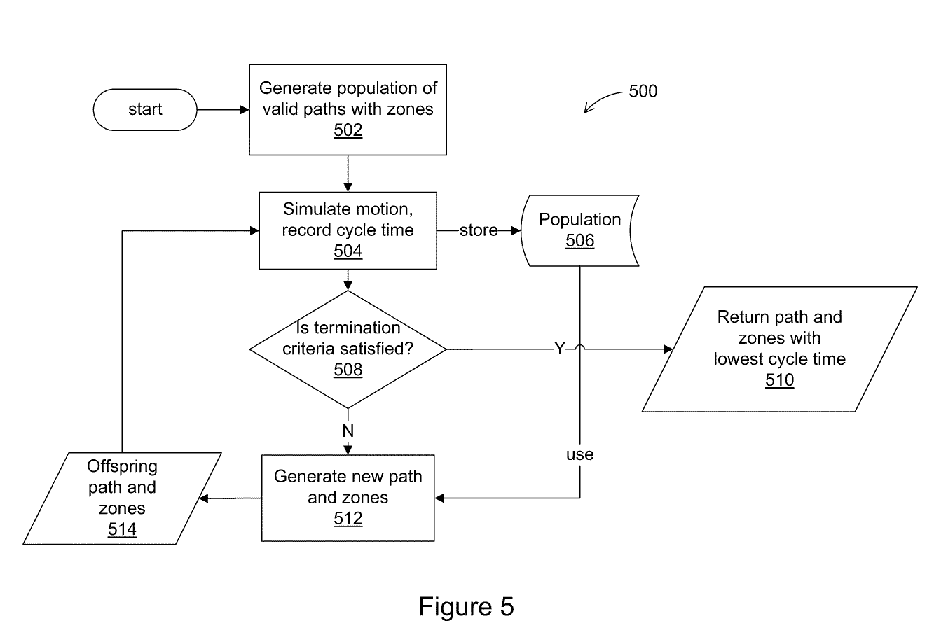

FIG. 5 depicts a “naive” automatic path planning process 500 using a genetic algorithm for generating candidate paths. In step 502, an initial population of paths is generated, where each path comprises one or more via locations with associated zones. In an initial pass through step 504, each path in the initial population is validated by simulating the path and checking for collisions. Paths with collisions (invalid paths) are eliminated and paths without collisions (valid paths) are stored in a population database 506. A cycle time is also stored in the population database 506 for each valid path.

In step 508, one or more termination criteria are evaluated. If the termination criteria are satisfied, in step 510 a path comprising waypoints and zones having a lowest cycle time are returned for use by a robot programmer. Termination criteria may relate to a diminishing measure of improvement in cycle time, a maximum number of iterations of the process 500, or other suitable criterion indicating that further iterations of the process 500 are not needed.

If the termination criteria are not satisfied, in step 512, the population database 506 is used to generate a new path that includes both via locations and zones. Both locations and zones may be modified in generating the new path from existing paths in the population database 510 using so-called “genetic operations” such as mutations and crossovers. The new path, with its via locations and zones, is stored in step 514. The method 500 then returns to step 504, where the new path is simulated and checked for validity. If the new path is valid, it is stored in the population database 506, along with its cycle time. The process 500 then continues to step 508 to check termination criteria.

The process 500 has some weak points. Mutations of the paths and zones in step 512 are typically based solely on statistical concepts and do not make use of any knowledge about zones. Zones are typically treated like another independent degree of freedom that the process tries to “guess” or estimate, Due to the increase in degrees of freedom, many simulations are needed, causing the process 500 to operate slowly to find a collision-free path with acceptable cycle time.

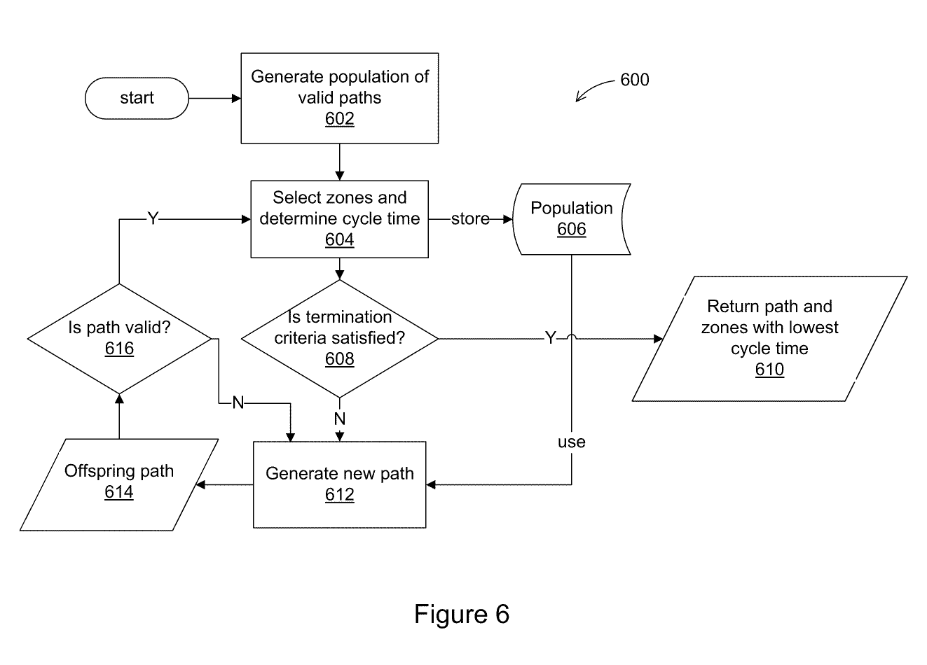

FIG. 6 depicts an automatic path planning process 600 in accordance with disclosed embodiments, as can be performed, for example, by the data processing system 100. In step 602, an initial population of valid paths is generated. The paths generated in step 602 include via locations but do not include zones Each initial path is validated for fine zones quickly and accurately using a standard (or generic) robot controller model. Any path that has collisions using fine zones is discarded in step 602, such that the initial population of paths includes only valid paths.

In an initial pass through step 604, a zone selection process according to the disclosure is performed for each path in the initial population. The process selects for each path a set of zones that are collision-free in simulated robot motion and provide a minimal(or near-minimal) cycle time for the simulated motion. The selected set of zones and simulated cycle time associated with each path are stored along with the path in the population database 606,

In step 608, one or more termination criteria are evaluated and, if satisfied, a path and associated zones having a lowest cycle time are returned for use by a robot programmer. As described with reference to FIG. 5, termination criteria may relate to a diminishing measure of improvement in cycle time, a maximum number of iterations of the process 600, or other suitable criterion indicating that further iterations of the process 600 are not needed. While minimum cycle time is one criterion for selecting a candidate path to return upon termination, it will be understood that in other embodiments other criteria may be used, such as simulated dynamic loads on drive and brake mechanisms of the robot's joints, maximum levels of acceleration/deceleration experienced by the robot during motion, and other suitable selection criteria.

If the termination criteria are not satisfied, in step 612 a new path is generated from paths in the population database 606. The process 600 generates new candidate paths from a population of paths using techniques of genetic algorithms. In other embodiments, a new path may be generated solely from the previous path, without the use of a population of paths, by techniques such as simulated annealing or other metaheuristic processes. Unlike the generation of a new path in step 512 of the process 500, in step 612 only waypoint locations (position and orientation) are modified in generating a new path and the new path has no associated zones. The new path, having only via, locations at this stage, is stored in step 614.

In step 616, the new path is validated for fine zones using a standard (or generic) robot controller model, If the new path experiences collisions even using fine zones, it may be discarded and the process 600 return to step 612 to generate another new path. Such validation of the new path using only a standard (or generic) robot controller is typically substantially faster than the validation of mutated locations and zones by full simulation in the process 500.

The new path may also be validated in step 616 by simulating the path using a largest possible set of zones, without testing for collisions. Applying Assumption 1, the cycle time for this path with largest zones is assumed to be the best possible cycle time achievable for the new path. If this cycle time does not meet a threshold criterion when compared to cycle times for paths already in the population database 606, then the new path may be discarded on the assumption that it will not advance the search for an optimum combination of locations and zones. In such a case, the process 600 returns to step 612 to generate another new path,

If the new path found valid in step 616, the process 600 returns to step 604, where the zone selection process according to the disclosure is performed for the new path to select a set of zones that are collision-free in simulated robot motion and provide a minimal cycle time. The new path, the selected set of zones, and the simulated cycle time are then stored in the population database 606 and the termination criteria evaluated again in step 608.

In the process 600, zones are not treated. as another independent degree of freedom as they are in the process 500. Instead, in process 600, for each path a set of zones is selected that yields a minimal cycle time, while keeping the path collision-free. Zone selection processes of the disclosure achieve this result by implementing two assumptions. First, that larger zones should be preferred over smaller zones. Second, that changing the zone on a specific location usually affects the robot motion only in a very limited region in the path, that is, the two adjacent segments (before and after the location). Furthermore, the cycle time of the path planning process 600 itself is reduced by not performing zone assignment on paths that have collisions with tine zones.

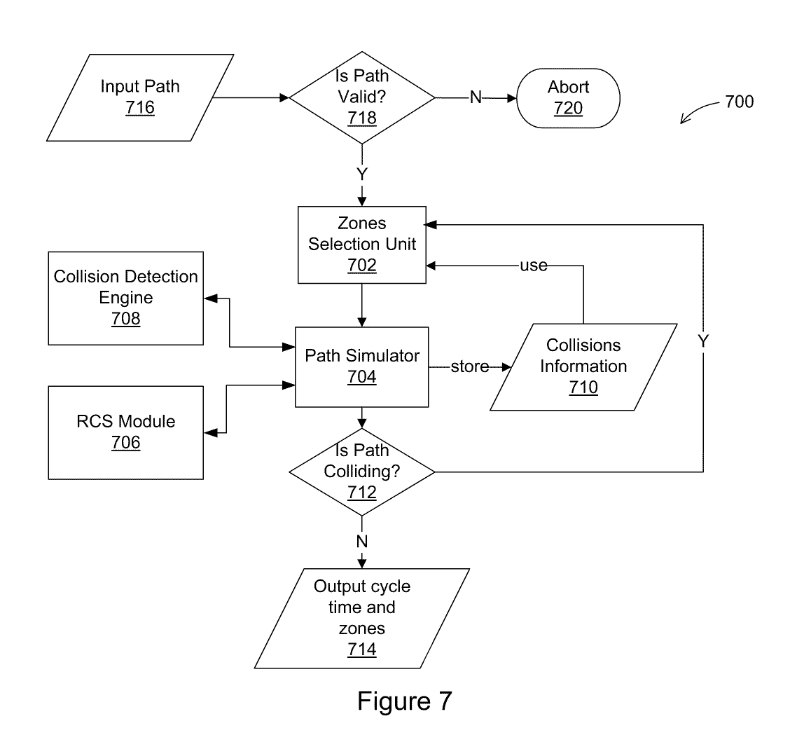

FIG. 7 depicts a zone assignment process 700 in accordance with disclosed embodiments, as can be performed, for example, by the data processing system 100, in step 702, a robotic path comprising a starting location, and ending location and one or more intermediate via locations is received and a plurality of zones are associated with each via location in the robotic path. An optimal zone (e.g., a largest zone) is selected for each via location from the plurality of zones associated with the location. The pairings of locations and associated currently selected zones are passed to a path simulator in step 704. More aspects of the zones selection unit 702 will be described below. The starting and ending locations may also be considered to be paired with fine zones, since the robot begins the path at a standstill at the starting location and ends the path by coming to a complete stop at the ending location.

The path simulator 704 may use an RRS interface to send information on path locations and currently selected zones to an RCS module 706, which simulates dynamic motion of the robot along the path described by the received locations and zones. As the RCS module 706 is operating, positions of the robot along the path are sent by the path simulator 704 to a collision detection engine 708. The collision detection engine 708 tests the received positions against static elements of the industrial environment of the robot to determine whether the positions represent a collision with an element of the environment, The path simulator 704 simulates the complete path, from starting location to ending location, in order to find all collisions along the path. The path simulator identifies segments of the path on which (i.e., between which via locations) the collisions occurred, as well as one or both via locations associated with the collision segment(s), and stores information on the location(s) and/or segments in a collisions information database 710. Information relating to a proximity of a collision to a location may also be stored in the collisions information database 710. The path simulator also records a cycle time for the simulated motion of the robot over the locations and currently selected zones of the path.

In step 712, the process 700 determines whether one or more collisions occurred with the zones currently selected for each via location on the path. If not, then in step 714 the currently selected zones are assigned to the via locations for robotic path), the recorded cycle time is assigned to the via locations and zones, and the locations, zones, and recorded cycle time are returned as an optimal set of zones for the path received in step 702. If the simulation of the path in step 704 determined that one or more collisions did occur, then the process 700 returns to step 702 to identify one or more locations associated with the one or more collisions and, for each of the one or more identified locations, select a zone from the plurality of zones associated with the location other than the currently selected zone for the location. The process 700 then returns to step 704 to simulate the path with the one or more newly selected zones.

Step 702 may employ a technique using a data structure such as the directed graph described with reference to FIGS. 3 and 4. In step 702, a directed graph may be created where each node represents an association of a location in the received robotic path with one of the plurality of zones associated with the location. Edges in the graph couple each vertex to all vertices assigned to immediately subsequent locations in the robotic path. Initially, zones with largest size (or edges with lowest weight) may be selected for the via locations by selecting a corresponding path through the graph. If one or more collisions are detected in step 704, information relating to the path segments on which the collisions occurred and associated via locations and their currently selected zones is stored in the collisions information database 710 and, when the process 700 returns to step 702, the zones selection unit 702 removes edges associated with those locations and their currently selected zones from the graph. A new path through the graph having a lowest total edge weight is then found by the zones selection unit 702. Such a path will select a new zone for at least one of the via locations associated with each collision segment found by the path simulator 704. The via locations and new currently selected zones for the path are then passed to the path simulator 704 for simulation and testing for collisions.

In other embodiments, the zones selection unit 702 may initially select zones of one or more intermediate sizes for each via location. If collisions are found for one or more segments using these zones, the zones selection unit 702 may remove from the graph edges terminating in (or coupled to) location-zone pairs for the intermediate size zones implicated in the collisions as well as any associated larger zones, significantly reducing the number of candidate paths in the graph.

In some embodiments, the zones selection unit 702 may additionally or alternatively reduce the number of candidate paths in the graph by employing knowledge regarding a maximum size of zone (or zone size limit) allowed by a robot controller to be used to control the robot. This may be done by removing from the graph edges leading to vertices assigned to zones having a size larger than the maximum zone size allowed by the robot controller. Subsequently, when paths are selected through the graph, zones will be selected for locations according to zone size limits imposed by the robot controller.

While the zones selection unit 702 is described above as utilizing a directed graph data structure to represent combinations of locations and zones, it will be understood that, in other embodiments, other suitable techniques for selecting candidate zones for locations may be used. In still other embodiments, rather than constructing a representation of all possible location-zone pairings, simulating an association of locations with intermediate sized zones, and then removing location-zone pairings from the representation, the association of locations with intermediate sized zones may be simulated and maximum zone size for certain locations limited before building a representation of location-zone pairings. Similarly, zone size limits imposed by robot controllers may be accommodated before building a representation of location-zone pairings.

In some embodiments, the path received by the zones selection unit 702 is assumed to be valid; that is, the path is assumed to be collision-free with fine zones. Where the process 700 is used as the zone selection process 604 in a process such as the process 600 of FIG. 6, validity of the received path is assured by the generation of only valid paths in the path generation step or by the validity test executed in step 616,

However, in other embodiments, the zone selection process 700 may be used in path planning processes that do not ensure the validity of paths provided for zone selection. In such embodiments, additional steps may be included in the process 700 to ensure that only valid paths are presented to the zone selection unit 702. In such embodiments, an input path 716 is tested for validity in optional step 718. If found valid, the path 716 is sent to the zones selection unit 702 for operation of the zone selection process 700. If the path 716 is found invalid in step 718, the process 700 may terminate in step 720 without assigning zones to the path.

Such embodiments that apply the zone selection process 700 only to valid paths are embodiments that implement Assumption 3: Paths that cause collisions without zones are considered invalid, even if the collisions can be avoided once zones are applied. However, path planning processes according to the disclosure may be developed that do not implement Assumption 3. In such embodiments, a path planning process such as the process 600 of FIG. 6 or a zone selection process such as the process 700 of FIG. 7 may be implemented that do not check candidate paths for being collision free with fine zones,

The zone assignment processes of the disclosure select an optimal set of zones for a given path using RRS and collision detection. The methods reduce redundant execution of RCS simulations by implementing assumptions that include larger zones should be preferred over smaller zones, and changing the zone on a specific location usually affects the robot motion only in a limited region in the path. The methods may also reduce redundant execution of RCS simulations by implementing an assumption that paths that cause collisions without zones are considered invalid. Use of such algorithms can be highly beneficial in manual and automatic path planning and optimization processes.

In sonic embodiments, the steps of the processes 600 and 700 of FIGS. 6 and 7, respectively, may be performed entirely by a data processing system such as the data processing system 100 of FIG. 1. In other embodiments, processes according to the disclosure may be performed by a plurality of data processing systems linked by an intranet, Internet, or other suitable communication network. For example, in some embodiments the RCS module 706 or the collision detection engine 708 may be implemented as an independent simulation system. Similarly, in some embodiments the population database 606 or the collisions information database 710 may be implemented as server storage at a location separate from a data processing system performing the steps of the process 600 or the process 700. In still other systems, the path planning process 600 may be performed on a first data processing system, while one or more additional data processing systems are employed to perform the zone selection process 700 and/or other steps of the process 600 independently and in parallel on a corresponding number of candidate paths. Similarly, in some embodiments one or more additional data processing systems are employed to perform the selection of zones in step 702, the simulation of paths in step 704, and/or other steps of the process 700 independently and in parallel on a corresponding number of candidate sets of zones.

Various papers describe features that may be related to some portions of the processes described herein, and are all incorporated by reference:

Hein, B., Salonia, M., Worn, H., “Automated generated collision-free time optimized robot movements in industrial environments based on rounding”. In ISATP, International Symposium on Assembly and Task Planning, pp. 110-115. (2001);

Sanchez, G., Ramos, F., & Frausto, J., “Locally-Optimal Path Planning by Using Probabilistic Road Maps and Simulated Annealing”. Proceedings of LASTED International Conference on Robotics and Applications, (1999);

Ahuactzin, J. M., Talbi, E.-G, Bessi`ere, P., and Mazer, E., “Using genetic algorithms for robot motion planning,” in Proc. of 10th European Conference on Artificial Intelligence, 671-675. (1992);

Pack, D., Toussant, G., Haupt, R., “Robot trajectory planning using a genetic algorithm”, SPIE, 2824, 171-182. (1996);

Yue, S. G. and Henrich D., “Point-to-point trajectory planning of flexible redundant robot manipulators using genetic algorithms”, To appear in Robotica. (2001); and

Tian, L., Collins, C., “An effective robot trajectory planning method using a genetic algorithm”, Mechatronics, 14, pp. 455-470. (2004).

According to various embodiments, one or more of the processes or steps described in relation to methods according to the disclosure may be performed alternately, concurrently, repeatedly, or in a different order, unless otherwise specifically described or claimed. “Receiving,” as used herein, can include loading from storage, receiving from another data processing system such as over a network, receiving via an interaction with a user, a combination of these, or otherwise, as recognized by those of skill in the art.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means” for are followed by a participle.

What is claimed is:

1. A method of robotic path planning, comprising:
receiving in a data processing system a robotic path for a robot;
associating a plurality of zones with each of a plurality of locations in the robotic path;
selecting in the data processing system for each location a currently selected one of the plurality of zones associated with the location;
simulating motion of the robot over the robotic path using, for each of the plurality of locations, the currently selected zone for the location;
determining whether a collision occurred in the simulated motion of the robot;
if a collision is determined to have occurred:
identifying in the data processing system a location associated with the collision;
selecting in the data processing system as a new currently selected zone for the identified location one of the plurality of zones associated with the location other than the currently selected zone; and
repeating the steps of simulating motion of the robot and determining whether a collision occurred; and
if a collision is determined not to have occurred, in the data processing system assigning to each location the zone currently selected for the location,

2. The method of claim 1, wherein:
associating a plurality of zones with each of a plurality of locations in the robotic path comprises creating a directed graph comprising vertices assigned to each association of a location and a zone and edges from each vertex to all vertices assigned to an immediately subsequent location in the robotic path;
selecting for each location a currently selected one of the plurality of zones associated with the location comprises selecting a path through the graph; and
selecting as a new currently selected zone for the identified location one of the plurality of zones associated with the location other than the currently selected zone comprises:
removing from the graph an edge associated with the identified location and the currently selected zone for the identified location; and
selecting a new path through the graph,

3. The method of claim 2, wherein:
creating a directed graph further comprises associating with each edge a weight value inversely proportional to a size of the zone associated with the target vertex of the edge; and
selecting a path through the graph comprises selecting a path having edges with a lowest total combined weight.

4. The method of claim 2, wherein each zone has a size and:
selecting a path through the graph comprises selecting, for each location, a vertex assigned to a zone having an intermediate size; and
if a collision is determined to have occurred, removing from the graph one or more edges coupled to vertices assigned to the identified location and associated with zones having a size equal to or larger than the currently selected zone for the identified location.

5. The method of claim 1, wherein each zone has a size and selecting in the data processing system for each location a currently selected one of the plurality of zones associated with the location comprises selecting, for each location, a largest zone of the plurality of zones associated with the location as the currently selected zone,

6. The method of claim 1, wherein each zone has a size and selecting in the data processing system for each location a currently selected one of the plurality of zones associated with the location comprises selecting a zone for each location according to a zone size limit associated with a robot controller for the robot.

7. The method of claim 1, wherein if a collision is determined not to have occurred, assigning to the robotic path and assigned zones an elapsed time for simulated motion of the robot over the robotic path using the assigned zones.

8. A data processing system comprising a processor and accessible memory, the data processing system particularly configured to perform the steps of:
receiving a robotic path for a robot;
associating a plurality of zones with each of a plurality of locations in the robotic path;
selecting for each location a currently selected one of the plurality of zones associated with the location;
causing simulation of motion of the robot over the robotic path using, for each of the plurality of locations, the currently selected zone for the location;
causing determination of whether a collision occurred in the simulated motion of the robot;
if a collision is determined to have occurred:
identifying in the data processing system a location associated with the collision;
selecting in the data processing system as a new currently selected zone for the identified location one of the plurality of zones associated with the location other than the currently selected zone; and
repeating the steps of simulating motion of the robot and determining whether a collision occurred; and
if a collision is determined not to have occurred, in the data processing system assigning to each location the zone currently selected for the location.

9. The data processing system of claim 8, the data processing system further configured to perform the steps of:
associating a plurality of zones with each of a plurality of locations in the robotic path by creating a directed graph comprising vertices assigned to each association of a location and a zone and edges from each vertex to all vertices assigned to an immediately subsequent location in the robotic path;
selecting for each location a currently selected one of the plurality of zones associated with the location by selecting a path through the graph; and
selecting as a new currently selected zone for the identified location one of the plurality of zones associated with the location other than the currently selected zone by:
removing from the graph an edge associated with the identified location and the currently selected zone for the identified location; and
selecting a new path through the graph.

10. The data processing system of claim 9, the data processing system further configured to perform the steps of:
creating a directed graph by associating with each edge a weight value inversely proportional to a size of the zone associated with the target vertex of the edge; and
selecting a path through the graph by selecting a path having edges with a lowest total combined weight.

11. The data processing system of claim 9, the data processing system further configured to perform the steps of:
selecting a path through the graph by selecting, for each location, a vertex assigned to a zone having an intermediate size of the plurality of zones associated with the location; and
if a collision is determined to have occurred, removing from the graph edges terminating in vertices assigned to the identified location and associated with zones having a size equal to or larger than the currently selected zone for the identified location.

12. The data processing system of claim 8, wherein each zone has a size and the data processing system is further configured to perform the step of:
selecting for each location a currently selected one of the plurality of zones associated with the location by selecting, for each location, a largest zone of the plurality of zones associated with the location as the currently selected zone.

13. The data processing system of claim 8, wherein each zone has a size and the data processing system is further configured to perform the step of:
selecting for each location a currently selected one of the plurality of zones associated with the location by selecting a zone for each location according to a zone size limit associated with a robot controller for the robot.

14. The data processing system of claim 8, the data processing system further configured to perform the step of:
if a collision is determined not to have occurred, assigning to the robotic path and assigned zones an elapsed time for simulated motion of the robot over the robotic path using the assigned zones.

15. A computer-readable storage medium encoded with computer-executable instructions that, when executed, cause a data processing system to perform the steps Of:
receiving a robotic path for a robot;
associating a plurality of zones with each of a plurality of locations in the robotic path;
selecting for each location a currently selected one of the plurality of zones associated with the location;
causing simulation of motion of the robot over the robotic path using, for each of the plurality of locations, the currently selected zone for the location;
causing determination of whether a collision occurred in the simulated motion of the robot;
if a collision is determined to have occurred:
identifying in the data processing system a location associated with the collision;
selecting in the data processing system as a new currently selected zone for the identified location one of the plurality of zones associated with the location other than the currently selected zone; and
repeating the steps of simulating motion of the robot and determining whether a collision occurred; and
if a collision is determined not to have occurred, in the data processing system assigning to each location the zone currently selected for the location.

16. The computer-readable storage medium of claim 15, further encoded with computer-executable instructions that, when executed, cause a data processing system to perform the steps of:
associating a plurality of zones with each of a plurality of locations in the robotic path by creating a directed graph comprising vertices assigned to each association of a location and a zone and edges from each vertex to all vertices assigned to an immediately subsequent location in the robotic path;
selecting for each location a currently selected one of the plurality of zones associated with the location by selecting a path through the graph; and
selecting as a new currently selected zone for the identified location one of the plurality of zones associated with the location other than the currently selected zone by:
removing from the graph an edge associated with the identified location and the currently selected zone for the identified location; and
selecting a new path through the graph.

17. The computer-readable storage medium of claim 16, further encoded with computer-executable instructions that, when executed, cause a data processing system to perform the steps of:
creating a directed graph by associating with each edge a weight value inversely proportional to a size of the zone associated with the target vertex of the edge; and
selecting a path through the graph by selecting a path having edges with a lowest total combined weight.

18. The computer-readable storage medium of claim 16, further encoded with computer-executable instructions that, when executed, cause a data processing system to perform the steps of:
selecting a path through the graph by selecting, for each location, a vertex assigned to a zone having an intermediate size of the plurality of zones associated with the location; and
if a collision is determined to have occurred, removing from the graph edges terminating in vertices assigned to the identified location and associated with zones having a size equal to or larger than the currently selected zone for the identified location.

19. The computer-readable storage medium of claim 15, further encoded with computer-executable instructions that, when executed, cause a data processing system to perform the steps of:
selecting for each location a currently selected one of the plurality of zones associated with the location, where each zone has a size, by selecting, for each location, a largest zone of the plurality of zones associated with the location as the currently selected zone.

20. The computer-readable storage medium of claim 15, further encoded with computer-executable instructions that, when executed, cause a data processing system to perform the steps of:
selecting for each location a currently selected one of the plurality of zones associated with the location, where each zone has a size, by selecting a zone for each location according to a zone size limit associated with a robot controller for the robot.

21. The data processing system of claim 8, the data processing system further configured to perform the step of:
if a collision is determined not to have occurred, assigning to the robotic path and assigned zones an elapsed time for simulated motion of the robot over the robotic path using the assigned zones,
